(19) United States
(12) Patent Application Publication
(10) Pub. No.: US 2009/0131120 A1
(43) Pub. Date: May 21, 2009

(54) Mobile Teminal Having Bluetooth Module

(76) Inventors: Chan-Hyun Park, Gyeonggi-do (KR); Beyong-In Choi, Gyeonggi-do (KR)

Correspondence Address: HARNESS, DICKEY & PIERCE, P.L.C., P.O. BOX 8910, RESTON, VA, 20195, US

(21) Appl. No.: 12/083,603

(22) PCT Filed: Sep. 13, 2006
(86) PCT No.: PCT/KR2006/003646

§ 371 Date: Apr. 15, 2008

(30) Foreign Application Priority Data
Oct. 25, 2005 (KR) 10-2005-0100528

(51) Int. Cl. H04M 1/00

(52) U.S. Cl. 455/569.1

(57) ABSTRACT

A mobile terminal having a bluetooth module is disclosed. The mobile terminal comprising an input unit positioned on the terminal for receiving outside sound signals and a codec positioned between the bluetooth module and the input unit can be connected to A/V devices to receive sound wirelessly.

### TECHNICAL FIELD

The present invention relates to a mobile terminal having a bluetooth module.

### BACKGROUND ART

Bluetooth generally refers to a form of short range, wireless communication which allows bidirectional real-time communication without complicated wiring, by inter-connecting computers and peripheral devices, mobile terminals and computers, appliances, etc., located within a short range to a wireless network. Bluetooth is a service for reducing loads for communication stations and for increasing the efficiency of mobile terminal use, by providing direct wireless communication between devices without depending on communication stations located long distances away, when data transmissions are required between devices.

Mobile terminal products using bluetooth modules and wireless headsets are recently making their appearance in the market. That is, mobile terminals are appearing in the market in which the bluetooth module installed on the main body of a mobile terminal can wirelessly transmit various data to a headset, etc. Such a mobile terminal having the bluetooth function allows convenient use of the terminal, as the wireless headset may be used in performing functions such as phone conversations, playing music files, and playing video clips.

However, the conventional mobile terminal having the bluetooth function plays music files, such as MP3, and video clip files stored in the terminal itself for wireless transmission to the headset, so that it is inferior to A/V (audio/video) devices such as MP3 players and DVD players in terms of sound quality and capacity.

### DISCLOSURE OF INVENTION

### Technical Problem

The invention provides a mobile terminal having a bluetooth module, which can be connected to A/V devices to receive sound wirelessly.

### Technical Solution

A mobile terminal having a bluetooth module, based on one aspect of the invention, comprises an input unit positioned on the terminal for receiving outside sound signals and a codec positioned between the bluetooth module and the input unit.

Embodiments of the invention may include one or more of the following features. For example, the input unit may be an ear jack module or an I/O jack module. Here, a bluetooth switch may further be included between the bluetooth module and the input unit.

The input unit may be a bluetooth jack module, where the bluetooth jack module may be connected directly to the codec.

### ADVANTAGEOUS EFFECTS

According to present invention as set forth above, a mobile terminal is provided which can be connected to A/V devices to receive sound wirelessly.

### BRIEF DESCRIPTION OF THE DRAWINGS

FIG. 1 is a block diagram of a mobile terminal having an ear jack module as an input unit, based on an embodiment of the invention.

FIG. 2 is a schematic diagram illustrating the mobile terminal of FIG. 1 in use.

FIG. 3 is a block diagram of a mobile terminal having an I/O jack module as an input unit, based on another embodiment of the invention.

FIG. 4 is a schematic diagram illustrating the mobile terminal of FIG. 3 in use.

FIG. 5 is a block diagram of a mobile terminal having a bluetooth jack module as an input unit, based on another embodiment of the invention.

FIG. 6 is a schematic diagram illustrating the mobile terminal of FIG. 5 in use.

### BEST MODE FOR CARRYING OUT THE INVENTION

Hereinafter, preferred embodiments of the mobile terminal based on the invention will be described in more detail with reference to the accompanying drawings. In the description with reference to the accompanying drawings, those components are rendered the same reference number that are the same or are in correspondence regardless of the figure number, and redundant explanations are omitted.

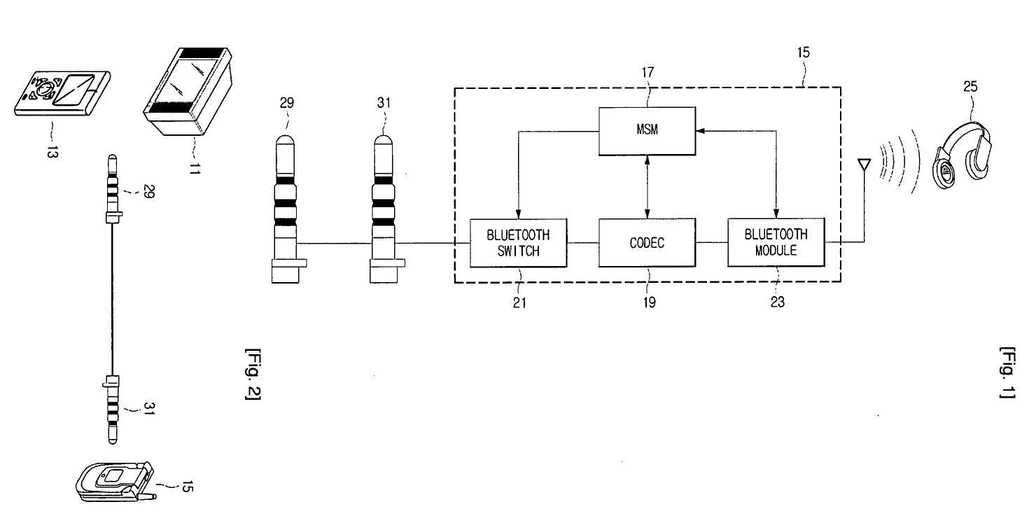

Referring to FIG. 1, a mobile terminal 15 based on an embodiment of the invention comprises a headset 25, a bluetooth module 23 which allows wireless communication, and an input unit 31 which receives sound signals as input from outside A/V devices. The codec 19, which is positioned between the input unit 31 and the bluetooth module 23, an MSM 17, which handles the overall control of the terminal 15, and a bluetooth switch 21, positioned between the bluetooth module 23 and the codec 19, are also comprised.

The bluetooth module 23, installed within the terminal, manages the bluetooth network and links. When it receives a command to search for peripheral devices (e.g. headset) from the MSM 17 during bluetooth communication, it identifies the peripheral devices currently located in its surrounding environment, reports them to the MSM 17, and afterwards performs short range wireless communication with these peripheral devices of voice, letter, or video data, etc.

The MSM 17 is a modem which performs modulation/demodulation and decoder functions for voice, letter, or video data, as well as performing various controls within the terminal, and when audio signals are received, it converts the signals to PCM (pulse code modulation) data and transmits it to the codec 19.

When the codec 19 receives analog audio signals from the bluetooth switch 21, it converts the signals to digital signals and outputs to the bluetooth module 23 and the MSM 17. On receiving signals from the codec 19, the MSM 17 controls the bluetooth module 23 to transmit the digital signals received from the codec 19 via the bluetooth module 23 to the headset 25 wirelessly.

When the input unit 31 is an ear jack module or an I/O jack module, the bluetooth switch 21 is positioned between the input unit 31 and the bluetooth module 23 to connect the input unit 31 and the codec 19.

The input unit 31 transfers outside sound signals received as input from an audio jack 29 to the bluetooth switch 31. A common ear jack module positioned on the mobile terminal may be used as the input unit 31, as well as an I/O jack module or a bluetooth jack module, which will be discussed using the embodiments below.

The audio jack 29 illustrated in FIG. 1 is connected to video devices, such as television sets, camcorders, and DVD players, or audio devices, such as CD players, MP3 players, and cassette tape players, etc., and receives audio signals from these devices. A common ear jack module may be used as the audio jack 29. Sound signals inputted through the audio jack 29 are transmitted to the input unit 31.

Referring to FIG. 1 and FIG. 2, the process is described by which sound signals played on A/V devices are transferred via the bluetooth module 23 using a cable to be transferred wirelessly to the headset 25.

Analog sound signals inputted through the audio jack 29 from audio devices, etc., such as MP3 players, are inputted to the bluetooth switch 21 via the input unit 31. Then, the analog sound signals inputted to the bluetooth switch 21 are inputted to the codec 19 and converted to digital signals, and then inputted to the bluetooth module 23 afterwards. The bluetooth module 23 wirelessly transmits the digitally converted audio signals to the headset 25, and the headset 25 plays the received audio signals.

Thus, using a cable, the mobile terminal having a bluetooth module based on the present invention may be used connected to audio devices such as MP3 players and video devices such as DVD players. Therefore, the mobile terminal and the A/V devices may be utilized more efficiently as compared to the mobile terminal of prior art having a limited capacity and a relatively low sound quality, since common A/V devices having relatively larger capacities and higher sound quality can be used.

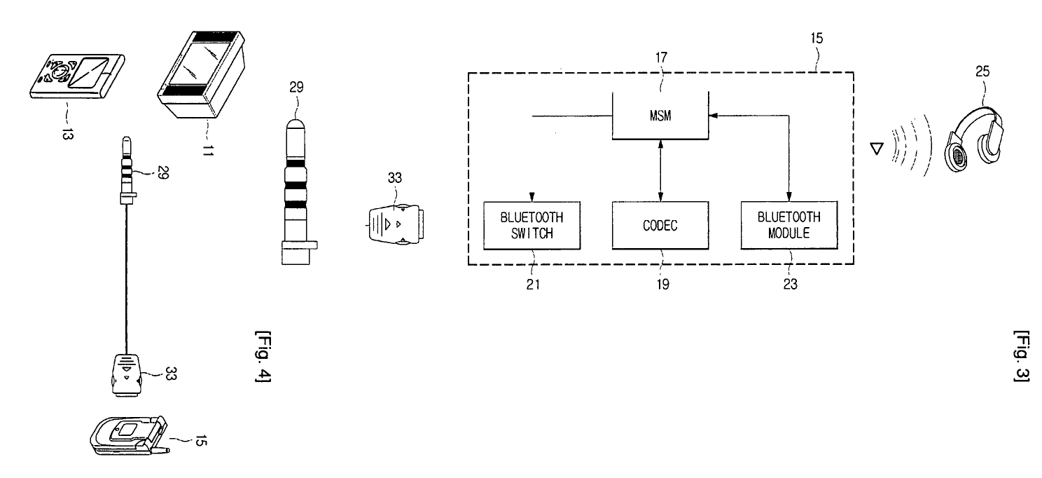

Referring to FIG. 3 and FIG. 4, a mobile terminal based on another embodiment of the invention comprises an I/O jack module 33 as the input unit. The I/O jack module 33 is connected to the bluetooth switch 21 using a common 28-pin connector, and sound signals are inputted through the pins of the I/O jack module 33 typically unused (for instance, pin nos. 25 to 28). Sound signals inputted through the I/O jack module 33 are transmitted via the codec 19 and the bluetooth module 23 to the headset 25, as explained in the embodiment set forth above.

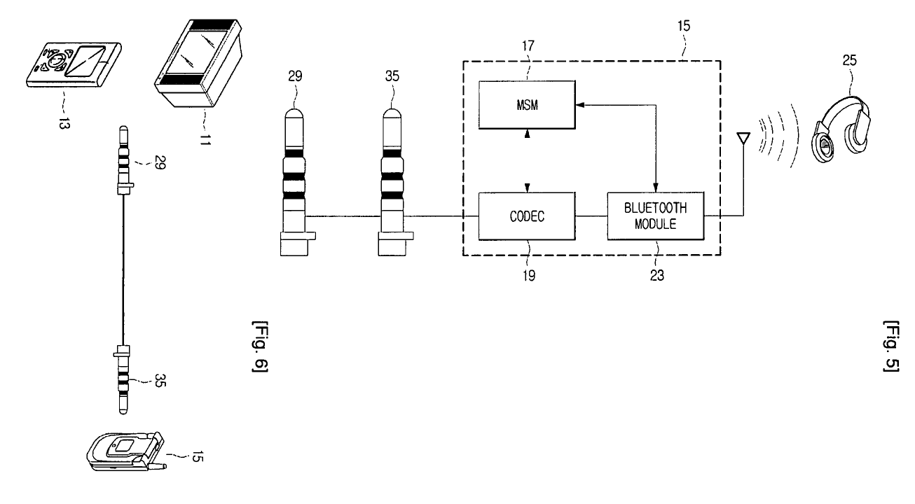

Referring to FIG. 5 and FIG. 6, a mobile terminal based on still another embodiment of the invention comprises a bluetooth jack module 35 as the input unit. As illustrated in FIG. 6, the bluetooth jack module 35 is connected directly to the bluetooth module 23, so that a separate bluetooth switch 21 is unnecessary.

While the invention has been described with reference to particular embodiments, various alterations and modifications may be made without departing from the scope of the invention, as long as they implement the spirit of the invention.

1. A mobile terminal having a bluetooth module, comprising:
an input unit positioned on the terminal for receiving outside sound signals; and
a codec positioned between the bluetooth module and the input unit.

2. The mobile terminal of claim 1, wherein the input unit is an ear jack module or an I/O jack module.

3. The mobile terminal of claim 2, further comprising a bluetooth switch between the bluetooth module and the input unit.

4. The mobile terminal of claim 1, wherein the input unit is a bluetooth jack module.

5. The mobile terminal of claim 4, wherein the bluetooth jack module is connected directly to the codec.
